(19) United States
(12) Patent Application Publication
(10) Pub. No.: US 2007/0051339 A1
(43) Pub. Date: Mar. 8, 2007

(54) Manufacturing method for plural valve assembly

(75) Inventors: Katsuya Torii, Anjo-city (JP); Masamichi Akagawa, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/513,019

(22) Filed: Aug. 31, 2006

(30) Foreign Application Priority Data
Sep. 2, 2005 (JP) 2005-254997

(51) Int. Cl. F02D 9/10; F16K 1/22; F02D 9/08

(52) U.S. Cl. 123/336; 251/305; 123/337

(57) ABSTRACT

A manufacturing method for a plural valve assembly is disclosed that includes providing a plurality of housings that each define a channel. Each housing includes at least one valve anchoring portion. The method also includes providing a plurality valves and providing a shaft. The method further includes coupling the plurality of valves to corresponding ones of the housings such that the valves can move relative to the housing between an open position and a closed position. The valves abut against the respective valve anchoring portion in the closed position. The method also includes coupling the shaft to the plurality of valves. Each of the plurality of valves abuts against the respective valve anchoring portion as the shaft is coupled thereto.

### CROSS REFERENCE TO RELATED APPLICATION(S)

The following is based on and claims priority to Japanese Patent Application No. 2005-254997, filed Sep. 2, 2005, which is hereby incorporated by reference in its entirety.

### FIELD

The following relates to a valve and, more particularly, relates to a valve assembly and, more particularly, relates to a manufacturing method for a plural valve assembly.

### BACKGROUND

Previously, air control systems with multiple and integral intake air control valves have been developed that are lighter weight and less expensive than original designs. For instance, housings and intake air control valves originally made from metal have been more recently made of resin. U.S. Pat. No. 6,979,130 (i.e., Japanese Patent No. 2003-509634), for instance, discloses components for such an air control valve.

More specifically, it discloses a valve unit formed with a resin intake air control valve in a resin housing. The resin housing has an elastic body structure so that the valve can be freely opened and closed. The device includes multiple valve units thus constructed, and they are arranged in a common casing (i.e., block) and aligned and spaced at equal intervals in the direction of the axis of a shaft. The casing forms part of the intake pipe (e.g. intake manifold) of an internal combustion engine. A single valve driving device to control the openings of the multiple intake air control valves. More specifically, a valve-side fitting portion is provided for each intake air control on the outer circumferential surfaces of the respective shaft-side fitting portions of one angular shaft. The shaft is rotationally driven by a valve driving device. Shaft through-holes are provided that penetrate the valve fitting portion of each intake air control valve. The shaft through-holes are polygonal in shape so as to match the shape of the angular shaft. The individual shaft-side fitting portions of the steel angular shaft are inserted into the shaft through-holes in the respective intake air control valves of the multiple valve units. Then, the steel angular shaft and the individual intake air control valves are prevented from rotating relative to each other.

However, conventional intake air control systems with multiple and integral intake air control valves suffer from certain disadvantages. For instance, in cases where the individual housings and intake air control valves of multiple valve units are all formed of resin, it is difficult to maintain high molding accuracy. Thus, there is the possibility that the angle at which each intake air control valve is assembled to the shaft-side fitting portions of the angular shaft can differ due to molding inaccuracy.

Therefore, when an attempt is made to vary the openings of multiple intake air control valves by one valve driving device as problem can arise as illustrated in FIG. 6. Multiple air control valves 101, 102 are shown in the housing 103, and because of molding accuracy described above, the set opening (i.e., valve opening) of each intake air control valve 101, 102 can vary. More specifically, the fully closed clearances (δ1, δ2) varies between the individual intake air control valves 101, 102, and the channel wall face of the housing 103. As a result, the actual closed position of each intake air control valve 101, 102 may deviate from a desired fully closed position. As such, the flow rate of leakage air is increased or varied when a valve is fully closed, and thus the performance of the engine is degraded.

### SUMMARY

A manufacturing method for a plural valve assembly is disclosed that includes providing a plurality of housings that each define a channel. Each housing includes at least one valve anchoring portion. The method also includes providing a plurality valves and providing a shaft. The method further includes coupling the plurality of valves to corresponding ones of the housings such that the valves can move relative to the housing between an open position and a closed position. The valves abut against the respective valve anchoring portion in the closed position. The method also includes coupling the shaft to the plurality of valves. Each of the plurality of valves abuts against the respective valve anchoring portion as the shaft is coupled thereto.

### BRIEF DESCRIPTION OF THE DRAWINGS

FIGS. 1A and 1B are sectional views illustrating one embodiment of an intake air flow control device, wherein FIG. 1A is a partially exploded, sectional view, and FIG. 1B is sectional end view;

FIG. 2 is a perspective view of the intake air flow control device of FIGS. 1A and 1B;

FIG. 3 is an exploded perspective view of the intake air flow control device of FIGS. 1A and 1B;

FIG. 4 is a sectional end view of the intake air flow control device of FIG. 1A and 1B;

FIG. 5 is a side view of another embodiment of a valve shaft with a tapered shaft outside diameter portion for the intake air flow control device; and

FIG. 6 is a sectional view of a prior art air control valve.

### DETAILED DESCRIPTION OF THE EMBODIMENTS

The following is a discussion of various embodiments of an intake air flow control device (i.e., a plural valve assembly) and a manufacturing method for the same. As will be discussed, the intake air flow control device is advantageous because variation in the flow rate of leakage fluid when valves are fully closed is unlikely even if the respective housings and valves of multiple valve units are formed of resin. This is because the closing position of each valve is uniform and variation is unlikely.

### First Embodiment

[Construction of First Embodiment]

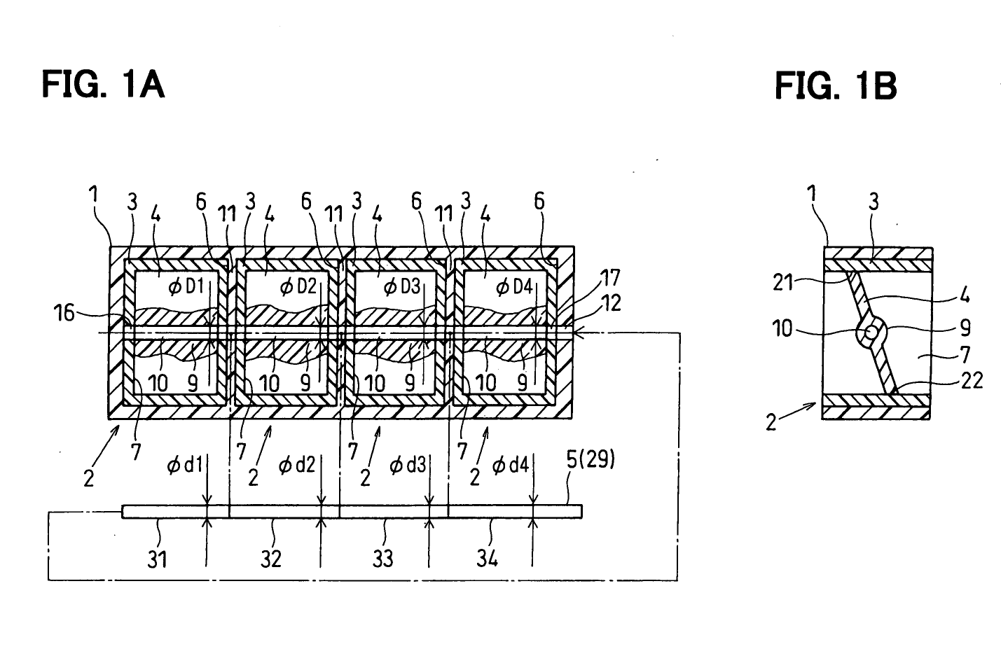

FIG. 1 to FIG. 4 illustrate a first embodiment of an intake air flow control device. In one embodiment, the intake air flow control device is employed in an internal combustion engine. The intake air flow control device in this embodiment is an intake air flow generator (i.e., a vortex flow generator). As such, the intake air flow generator is capable of generating an intake air vortex flow in the vertical direction (tumble flow) for facilitating the combustion of air-fuel mixture in each cylinder of a multicylinder internal combustion engine (e.g., a four-cylinder gasoline engine). The internal combustion engine is mounted in a vehicle such as automobile. The engine is so designed as to obtain output by thermal energy obtained by burning an air-fuel mixture of intake air and fuel in combustion chambers. The engine includes a cylinder head (not shown) hermetically joined with the downstream end of an intake pipe. The engine also includes a cylinder block (not shown) that forms the combustion chambers into which an air-fuel mixture is sucked from the intake ports in the shape of three-dimensional intake air channel provided in this cylinder head.

On the cylinder head, there are installed spark plugs (not shown) with tips exposed in the combustion chambers in the respective cylinders. On the cylinder head, there are also installed injectors (not shown) that inject fuel into the intake ports with predetermined timing. The multiple intake ports formed on one side of the cylinder head are opened and closed by poppet intake valves. The multiple exhaust ports formed on the other side of the cylinder head are opened and closed by poppet exhaust valves.

The intake pipe includes an air cleaner case that houses and holds an air cleaner (i.e., filtering element) for filtering intake air and a throttle body joined downstream of the air cleaner case with respect to the direction of intake air flow. The intake pipe also includes a surge tank joined downstream of the throttle body, an intake manifold joined downstream of the surge tank, and the like. The intake manifold is an intake air manifold that distributes and supplies intake air to intake ports of the cylinders provided in the cylinder head of the engine. In one embodiment, the intake manifold is formed of resin for the purpose of weight and cost reduction, and the intake manifold is integrally formed using resin material (e.g. thermoplastic resin reinforced with glass fiber). In one embodiment, the intake air flow generator is integrally provided in the intake pipe.

The intake air flow generator includes a casing 1 that defines a part of the intake pipe of the engine. The intake air flow generator also includes a plurality of resin housings 3. For instance, in the embodiment shown, there are four housings 3. The housings 3 are supported and secured in the casing 1. In the embodiment shown, the housings 3 are separate, but attached to the casing 1. In another embodiment, the housings 3 are integrally attached to the casing 1.

The intake air flow generator also includes a plurality of resin valves 4 corresponding in number to the housings 3. The resin valves 4 are provided and housed in corresponding housings 3. The resin valves 4 are movably supported within the respective housings 3 so that the resin valves 4 can move between an open position and a closed position. The air flow generator also includes a valve driving device with a valve shaft 5 capable moving each of the plurality of valves 4. In the embodiment shown, rotation of the valve shaft 5 about its axis rotates the valves 4 between the open and closed positions, respectively. In the embodiment shown, the valve units 2 are aligned and are equally spaced along the axis of the valve shaft 5. Thus, the intake air flow generator constitutes an intake air flow control valve module with a plurality of valve opening/closing devices.

In one embodiment, the valve driving device includes an actuator, such as an electric actuator. The electric actuator is provided with a power unit, such as an electric motor, and a power transmission mechanism (i.e., mechanical reduction mechanism) for transmitting the rotational motion of the output shaft of the motor to the valve shaft 5. The motor may be of any type, such as a brushless or brushed direct-current (DC) motor or an alternating-current (AC) motor (e.g., a three-phase induction motor). The mechanical reduction mechanism reduces the rotation speed of the motor shaft of the electric motor so that a predetermined reduction ratio is obtained. In one embodiment, the valve driving device is controlled by an engine control unit (ECU).

The casing 1 in this embodiment is a block (i.e., an automobile part, engine part, or resin intake manifold) that forms at least a portion of the intake manifold. It is integrally formed in the shape of a rectangular parallelpiped using resin material such as thermoplastic resin. The casing 1 is provided with a plurality of fitting apertures 6 (i.e., valve unit housing portions). In the embodiment shown, there are four fitting apertures 6 that house and hold the housings 3 of the valve units 2. The casing also includes partitioning walls 11 that hermetically partition two adjoining fitting apertures 6.

Further, the casing 1 is provided with a plurality of shaft through-holes 12. In the embodiment shown, there are five shaft through-holes 12. The shaft through-holes 12 are each axially straight and axially aligned through the partitioning walls 11 of the casing 1. The axes of the through-holes 12 are approximately perpendicular to the direction of airflow. The shaft through-holes 12 also extend through the fitting apertures 6 and all the partitioning walls 11. In the Figures, only one shaft through-hole 12 is omitted.

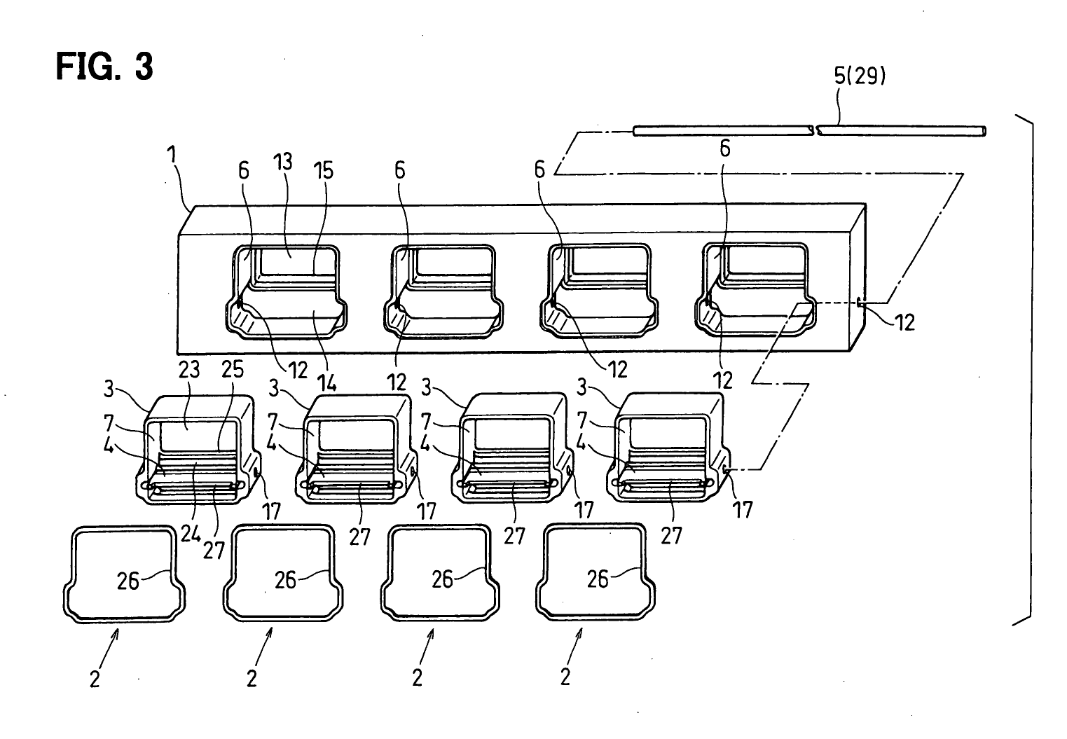

As shown in FIG. 3, the casing 1 also includes rectangular cylindrical diaphragm portions 15 integrally formed on the end face of the casing 1 downstream of the respective air channel 7. The diaphragm portions 15 divide the interior of the respective housing 3 into first air passages 13 and second air passages 14. Each first air passage 13 is defined above the respective second air passage 14.

The valve units 2 are provided in correspondence with the number of the cylinders of the engine. The valve units 2 each have air channels 7 and shaft through-hole 10. The air channels 7 have a rectangular sectional shape. Intake air flows through the air channels 7. The shaft through-holes 10 are respectively provided for the intake air flow control valves 4.

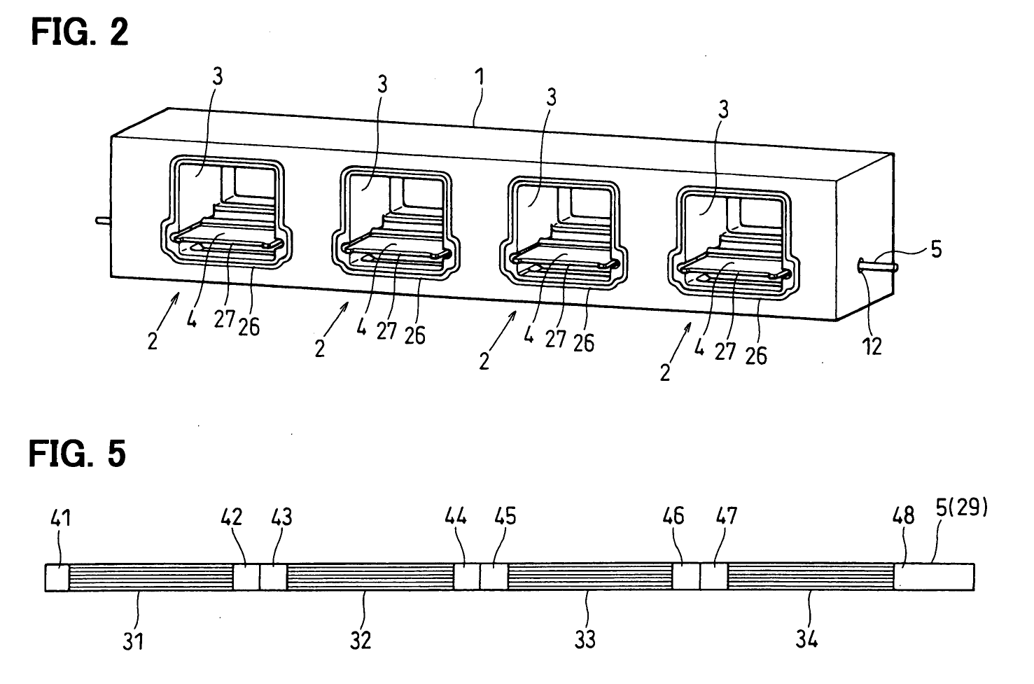

Of the plurality of valve units 2, there is a first valve unit 2 into which the valve shaft 5 is inserted last (i.e., after the valve shaft 5 has been inserted into all of the other valve units 2). In the embodiment shown, the first valve unit 2 is shown to the far left in FIGS. 2 and 3. Also, there is a second valve unit 2 into which the valve shaft 5 is inserted before the first valve unit 2 and after the other valve units 2. In the embodiment shown, the second valve unit 2 is shown to the immediate right of the first valve unit 2 in FIGS. 2 and 3. Furthermore, there is a third valve unit 2 into which the valve shaft 5 is inserted before the second valve unit 2 and after the other valve unit 2. In the embodiment shown, the third valve unit 2 is shown to the immediate right of the second valve unit 2 in FIGS. 2 and 3. Moreover, there is a fourth valve unit 2 into which the valve shaft 5 is inserted first (i.e., before the third valve unit 2). In the embodiment shown, the fourth valve unit 2 is shown at the extreme right of FIGS. 2 and 3. Hereinafter, reference will be made to first, second, third, and fourth housings 3, first, second, third, and fourth air channels 7, and the like. It will be appreciated that the locations of the first through fourth housings 3, first through fourth air channels 7, etc. correspond to the locations of the first through fourth valve units 2 described above.

In the embodiment shown, the first through fourth housings 3 are each oblong (or rectangular) and cylindrical that define a respective fluid channel 7 therein (i.e., first through fourth air channels 7). The first through fourth housings 3 are all formed of resin, and are integrally formed of resin material such as thermoplastic resin. Specifically, each housing 3 includes upper and lower channel wall faces and left and right channel faces spaced such that the first to fourth air channels 7 are substantially rectangular in shape. The first to fourth air channels 7 are fluidly connected to respective cylinders (i.e., combustion chambers) of the engine through the multiple intake ports independently (correspondingly) connected to the first to fourth valve units 2. In each of the first to fourth housings 3, shaft housing holes 16, 17 extend axially through the left and right channel faces of the first through fourth housings 3.

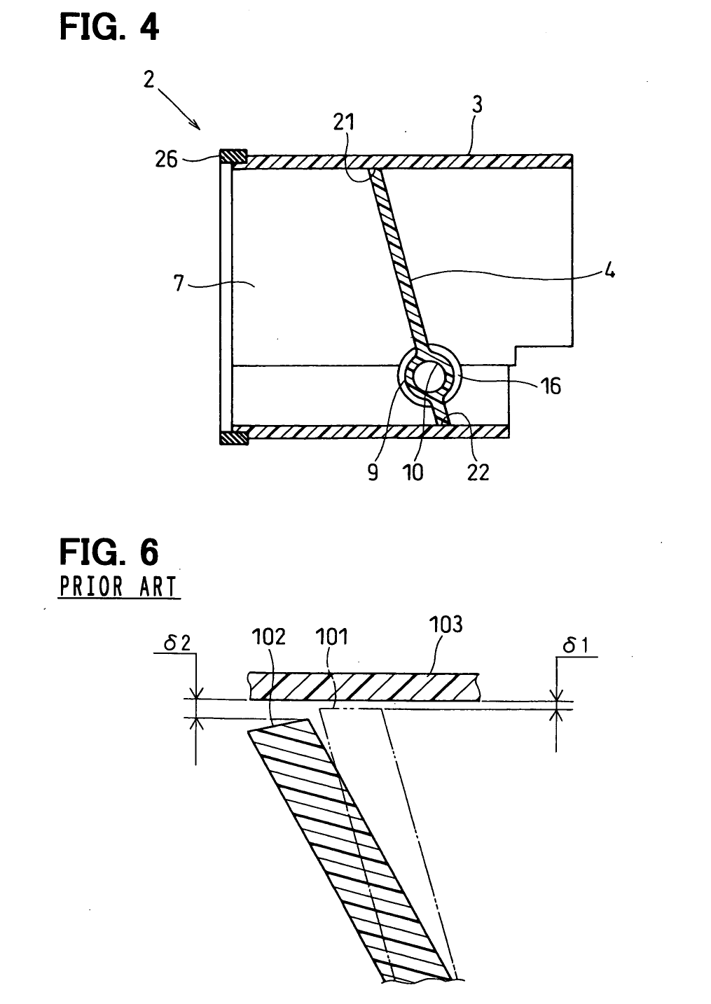

The channel wall faces of the first to fourth housings 3 are provided with valve anchoring portions 21, 22 (see FIGS. 1B and 4). In particular, the upper channel wall faces and the lower channel wall faces of the first to fourth housings 3 are each provided with the valve anchoring portions 21, 22. As illustrated in FIG. 4, the valve anchoring portions 21, 22 abut with the first to fourth intake air flow control valves 4. As such, the valve anchoring portions 21, 22 arrest rotational motion of the first to fourth intake air flow control valves 4 past a predetermined rotational angle. More specifically, the valve anchoring portions 21, 22 abut against the respective control valve 4 when the respective control valve 4 is in the fully closed direction. Thus, the valve anchoring portions 21, 22 function as stoppers when the abutted faces of the first to fourth intake air flow control valves 4 abutted against the respective valve anchoring portions 21, 22.

A plurality of gaskets 26 are also included. In one embodiment, the gaskets 26 are made of rubber. The gaskets 26 coupled onto the upstream end faces of the first to fourth housings 3. The annular gaskets 26 hermetically seal the area between the housings 3 and the downstream end of the intake pipe (i.e., air intake duct, throttle body, surge tank, intake pipe, or the like).

The first to fourth intake air flow control valves 4 in this embodiment are square-shaped and plate-like bodies. In another embodiment, the valves 4 are disc-shaped or rectangular shaped. In each intake air flow control valves 4, there is formed a through-hole 10 (i.e., first to fourth shaft through-holes 10) that extend through the interior of the valves 4 in the direction of the axis of the valve shaft 5. The first to fourth intake air flow control valves 4 are each formed of resin, and are integrally formed in predetermined shape using resin material such as thermoplastic resin. The first to fourth intake air flow control valves 4 are butterfly valves. The intake air flow control valves 4 have an axis of rotation in the direction perpendicular to the direction of the axes of the first to fourth housings 3.

The rotation angle of the first to fourth intake air flow control valves 4 can vary between the fully open position to the fully closed position. In the fully open position, the flow rate of intake air flowing in the first to fourth air channels 7 is at a maximum. In the fully closed position, the flow rate of intake air flowing in the first to fourth air channels 7 is at a minimum.

At least one biasing member (not shown) is also included, such as a coil spring. The biasing member biases the first to fourth intake air flow control valves 4 toward the fully open position.

As shown in FIG. 4, the axis of rotation of the first to fourth intake air flow control valves 4 are spaced vertically downward from the axis of the air channels 7. As such, the first to fourth intake air flow control valves 4 are cantilevered.

Each of the intake air flow control valves 4 is substantially enclosed by the four sides of the respective housing 3. The four sides of the housing 3 includes an upper and lower side (i.e., upper and lower end faces) positioned at opposite vertical ends, and left and right sides positioned at opposite horizontal ends.

Each of the valves 4 includes an opening portions 27 for forming desired intake air flows. In the embodiment shown, each opening portion 27 is a cutaway of the center portion of one edge of the respective valve 4. In the embodiment shown, the opening portion 27 is included at a top end of the respective valve 4 (i.e., the end at the top of the valve 4 when the valve 4 is in the closed position). In another embodiment, the opening portion 27 is included at the bottom end of the respective valve 4.

The first to fourth intake air flow control valves 4 constitute valve barrel-integrated intake air flow control valves. More specifically, the valves 4 are provided with cylindrical valve barrels 9 (hereafter, referred to as first to fourth valve-side fitting portions 9). Each fitting portion 9 is coupled to the outer surface of the valve shaft 5. In one embodiment, the fitting portion 9 is frictionally fit (i.e., coupled by friction) to the valve shaft 5. In another embodiment, the fitting portion 9 is welded to the shaft 5 (e.g., via vibrational welding or laser welding) instead of or in additional to the frictional fit.

More specifically, in the first to fourth valve-side fitting portions 9, there are formed the first to fourth shaft through-holes 10 with a round profile. The axes of the through-holes 10 of the valves 4 are aligned. The valve shaft 5 extends through the through-holes 10 of the fitting portions 9 to thereby couple the valve shaft 5 and the valves 4.

In one embodiment, the diameter of the through-holes 10 is varies between the valves 4. More specifically, the inside diameters of the first to fourth shaft through-holes 10 are such that the diameter of the first through-hole is smaller than the second, the second is smaller than the third, and the third is smaller than the fourth (i.e., φ1<φD2<φD3<φD4).

The valve shaft 5 is integrally formed in predetermined shape using resin material such as thermoplastic resin. That is, the valve shaft 5 is a resin shaft. The. valve shaft 5 includes an anterior end and a posterior end. The anterior end is inserted into the cavity 1 and through the housings 3 for attachment to the valves 4 before the posterior end. Thus, in the embodiment shown in FIG. 1A, the leftmost end of the shaft 5 is the anterior end, and the rightmost end of the shaft 5.

The outer diameter 29 of the shaft 5 varies along its length such that the anterior end of the shaft 5 is smaller than the posterior end of the shaft 5. In one embodiment, for instance, the outer diameter 29 of the shaft 5 is tapered (i.e., has a frustoconic shape) so as to gradually increase in size from the anterior end to the posterior end. In another embodiment, the outer diameter 29 of the shaft 5 is stepped such that the outer diameter of the shaft 5 increases in defined steps from the anterior end to the posterior end. In still another embodiment, a portion of the shaft 5 is tapered and another portion of the shaft 5 is stepped.

Thus, in the shaft outside diameter portion 29 of the valve shaft 5, there are integrally formed multiple shaft-side fitting portions 31, 32, 33, 34 (i.e., valve holding portions) of different sizes. The outer diameter 29 of the fitting portions 31, 32, 33, 34 correspond to the varying sizes of the through holes 10 of the valves 4. In other words, the shaft-side fitting portions 31, 32, 33, 34 are respectively provided in correspondence with the first to fourth intake air flow control valves 4 of the first to fourth valve units 2. The outside diameters φd1, φd2, φd3, φd4 of the first to fourth shaft-side fitting portions 31, 32, 33, 34 are such that the first diameter φd1 is smaller than the second diameter φd2, the second diameter φd2 is smaller than the third diameter φd3, and the third diameter φd3 is smaller than the fourth diameter φd4 (i.e., φd1<φd2<φd3<φd4).

In order to frictionally couple the shaft 5 to the valves 4, the anterior end of the shaft 5 is first inserted into the through hole 12 of the casing 1 adjacent the fourth housing 3. Then, the anterior end of the shaft 5 advances further and is inserted into the shaft housing holes 16, 17 of the fourth housing 3 and the through hole 10 of the fourth valve 4. Next, the anterior end of the shaft 5 advances further and is inserted into the shaft housing holes 16, 17 of the third housing 3 and the through hole 10 of the third valve 4. Subsequently, the anterior end of the shaft 5 advances further and is inserted into the shaft housing holes 16, 17 of the second housing 3 and the through hole 10 of the second valve 4. Finally, the anterior end of the shaft 5 advances further and is inserted into the shaft housing holes 16, 17 of the first housing 3 and the through hole 10 of the first valve 4.

As the fourth shaft-side fitting portion 31 advances into the shaft hole 10 of the fourth valve 4, friction therebetween couples the shaft 5 to the fourth valve 4. Likewise, as the third shaft-side fitting portion 32 advances into the shaft hole 10 of the third valve 4, friction therebetween couples the shaft 5 to the third valve 4. Furthermore, as the second shaft-side fitting portion 33 advances into the shaft hole 10 of the second valve 4, friction therebetween couples the shaft 5 to the second valve 4. Finally, as the first shaft-side fitting portion 34 advances into the shaft hole 10 of the first valve 4, friction therebetween couples the shaft 5 to the first valve 4. In one embodiment, the shaft is further welded (e.g., vibrationally welded or laser welded) to the valves 4.

In one embodiment, the casing 1, first to fourth housings 3, first to fourth intake air flow control valves 4, and valve shaft 5 are thermoplastic resin products (resin molds) manufactured using an injection molding method (resin integral molding). More specifically, pellet-like resin material is heated and melted, pressure is applied to the molten resin, and the molten resin is injected into the cavity in an injection mold. Then, the resin is cooled and solidified (hardened) and removed from the injection mold. The resin can be of any suitable type including, but not limited to, polyamide resin (PA), unsaturated polyester resin (UP), polyphenylene sulfide (PPS),. polybutylene terephthalate (PBT), etc.

Thus, the method of manufacturing the valve assembly begins with providing the casing 1, the housings 3, the valves 4, and the shaft 5, for instance, by injection molding processes. Then, the valve units 2 are formed by movably coupling the intake air flow control valves 4 to the respective housings 3 in the respective air channels 7. Next, the first to fourth valve units 2 are coupled to the first to fourth fitting apertures 6 in the casing 1. Thus, multiple valve units, or the first to fourth valve units 2 are arranged at equal intervals and aligned in the common casing 1.

Subsequently, the first to fourth intake air flow control valves 4 are moved to their fully closed position using a jig or the like. Thus, the upper and lower end faces (abutted faces) of the first to fourth intake air flow control valves 4 are brought into abutment with the valve anchoring portions 21, 22 of the respective channel wall faces, as illustrated in FIG. 4.

With the valves 4 held in the closed position (i.e., abutting the valve anchoring portions 21, 22), the shaft 5 is inserted and coupled to the valves 4 as detailed above. In one embodiment, the valves 4 are held together in the closed position as the shaft 5 is inserted. In another embodiment, each valve 4 is individually moved to the closed position just before the shaft 5 is inserted. As explained above, once the shaft 5 is inserted, the valves 4 are frictionally coupled thereto, and as such, rotation of the shaft 5 rotates the valves 4 in unison between the open and closed positions.

Thus, the desired relative position between the valves 4 and the respective housings 3 can be ensured. In other words, variation in valve opening from valve to valve is unlikely. More specifically, because each of the valves 4 is in the fully closed position when coupled to the shaft 5, the same amount of rotation of the shaft 5 will cause each of the valves 4 to move to the fully closed position. Accordingly, operation of the valve assembly will be enhanced. Furthermore, the valve assembly can be manufactured more quickly and less expensively.

[Action of First Embodiment]

Brief description will be given to the action of the intake air flow control device (intake air flow generator) for internal combustion engines in this embodiment with reference to FIG. 1 to FIG. 4.

In cases where it is required to produce a tumble flow, all the first to fourth intake air flow control valves 4 are closed. Thus, intake air filtered through the air cleaner flows through the opening portions 27 of the first to fourth intake air flow control valves 4 and in proximity to the wall faces of the first air passages 13 positioned on the upper layer side, and is supplied to the intake ports. Further, the intake air goes around the intake valves and is introduced into the combustion chamber of each cylinder of the engine. Substantially. all of the intake air introduced into the combustion chambers passed through the opening portions 27 of the first to fourth intake air flow control valves 4. Therefore, the flow of intake air introduced into the combustion chambers makes an intake air vortex flow in the vertical direction (tumble flow).

More specific description will be given. When the first to fourth intake air flow control valves 4 are fully closed, the following can be implemented: air-fuel mixture can be guided into the combustion chambers through the opening portions 27 of the first to fourth intake air flow control valves 4, the first air passages 13 on the upper layer side (the upper layer portion of the intake air passage in the intake manifold), and the upper layer portions of the intake ports. Therefore, an intake air vortex flow in the vertical direction (tumble flow) can be easily generated in the combustion chambers. Thus, a tumble flow for promoting the combustion of air-fuel mixture in the combustion chamber in each cylinder of the engine can be aggressively generated. As a result, fuel can be burned at an air-fuel ratio at which fuel is usually less prone to be burned (lean combustion), and fuel economy can be improved without degrading the performance of the engine.

[Effect of First Embodiment]

As described in detail above, the manufacturing method reduces variation between in the fully closed positions of the valves 4. Thus, for each valve unit 2, there is likely to be the same amount of clearance between the valve 4 and its respective housing 3. Further, deviations from the fully closed position of the valves 4 are unlikely. Therefore, variation in the amount of intake air from cylinder to cylinder can be suppressed in the engine. Further, increase or variation in the flow rate of leakage air is reduced when the first to fourth intake air flow control valves 4 are fully closed, and thus, the performance of the engine can be enhanced.

In addition, assembly is relatively quick. This is because the frictional coupling between the shaft 5 and the valves 4 occurs just as the shaft 5 is fully inserted into the casing 1. As a result, the assembling workability can be enhanced when the shaft outside diameter portion 29 of the valve shaft 5 is assembled into the first to fourth shaft through-holes 10 in all the first to fourth intake air flow control valves 4. Subsequent welding of the shaft 5 to the valves 4 further ensures robust coupling.

As mentioned above, the casing 1, first to fourth housings 3, first to fourth intake air flow control valves 4, and valve shaft 5 are formed of resin material. Therefore, the casing 1, first to fourth housings 3, first to fourth intake air flow control valves 4, and valve shaft 5 are identical in coefficient of linear expansion. Thus, the amount of thermal expansion will be relatively the same for each component, thereby avoiding malfunction.

### Second Embodiment

FIG. 5 is a drawing illustrating a second embodiment of the invention and shows the tapered shaft outside diameter portion of the valve shaft.

The valve shaft 5 in this embodiment is a shaft having a polygonal sectional shape. In one embodiment, the valve shaft 5 is made of ferrous metal material. Cross sections of the shaft 5 are perpendicular to the rotation center axis are in polygonal shape (e.g. quadrangular shape). The first to fourth valve-side fitting portions 9 of the first to fourth intake air flow control valves 4 are supported and secured on the outer circumferential surfaces of the first to fourth shaft-side fitting portions 31, 32, 33, 34 of the valve shaft 5 by frictional fit (i.e., press fit). In one embodiment, the first to fourth valve-side fitting portions 9 of the first to fourth intake air flow control valves 4 are reinforced.

Like the shaft 5 of the first embodiment, the size of the shaft 5 increases along its length from the anterior end to the posterior end. The shaft 5 can be tapered, stepped, or a combination of the two as described above.

On the outer circumferential surface of the shaft outside diameter portion 29 of the valve shaft 5 in this embodiment, there are a plurality of integrally attached bearing sliding portions 41, 42, 43, 44, 45, 46, 47, 48. The bearing sliding portions 41-48 are rotatably supported in the first to fifth shaft through-holes 12 of the casing 1 and the shaft housing holes 16, 17 of the first to fourth housings 3. Thus, the bearing sliding portions 41-48 can rotate freely in those holes 12, 16,17.

In the valve shaft 5 in this embodiment, the outer circumferential surfaces of the first to fourth shaft-side fitting portions 31, 32, 33, 34 are provided at equal intervals on the shaft 5. Also, the outside diameter portion 29 of each is knurled. For example, knurls (i.e., a pattern of projections and depressions) are formed on part or all of the outer circumferential surfaces of the first to fourth shaft-side fitting portions 31 to 34. Thus, it is possible to enhance the frictional fit between the inner circumferential surfaces of the first to fourth valve-side fitting portions 9 of the first to fourth intake air flow control valves 4 and the outer circumferential surfaces of the first to fourth shaft-side fitting portions 31-34 of the valve shaft 5. As a result, it is unlikely for the valves 4 to rotate relative to the shaft 5.

[Modifications]

In the above embodiments, the intake air flow control device (intake air flow generator, vortex flow generator) for internal combustion engines is so constructed that the following can be implemented: an intake air vortex flow in the vertical direction (tumble flow) for promoting the combustion of air-fuel mixture in the combustion chamber in each cylinder of an engine is generated. Instead, the intake air flow control device (intake air flow generator, vortex flow generator) for internal combustion engines may be so constructed that the following can be implemented: an intake air vortex flow in the lateral direction (swirl flow) for promoting the combustion of air-fuel mixture in the combustion chamber in each cylinder of an engine is generated. Or, the intake air flow control device (intake air flow generator, vortex flow generator) for internal combustion engines may be so constructed that the following can be implemented: a squish swirl for promoting combustion in an engine is generated.

In the above embodiments, the invention is applied to an intake air flow control device for internal combustion engines that controls intake air sucked into the combustion chamber in each cylinder of an internal combustion engine. Instead, the invention may be applied to an intake air control system for internal combustion engines that controls the flow rate of intake air sucked into the combustion chamber in each cylinder of an internal combustion engine. In this case, an intake air flow rate control valve, such as idle rotation speed control valve or throttle valve, is assembled into a housing. Or, the invention may be applied to an exhaust gas recirculation system equipped with an EGR control valve that controls the reflux flow rate of exhaust gas. Exhaust gas recirculation is that part of the exhaust gas of an engine is recirculated from an exhaust passage to an intake air passage.

The invention may be applied to a variable intake system for internal combustion engines, equipped with a variable intake valve. The variable intake valve is an intake control valve for internal combustion engines, so designed as to vary the passage length or passage sectional area of the intake air passage in an intake manifold in correspondence with engine rotation speed. The variable intake system for internal combustion engines is a device capable of enhancing the engine output shaft torque (engine torque) regardless of engine rotation speed. This is implemented, for example, as follows: when the engine rotation speed is in the low/medium rotation speed range, the intake air passage in an intake manifold is switched by a variable intake valve so that the passage length of the intake air passage in an intake manifold is increased; when the engine rotation speed is in the high rotation speed range, the passage length of the intake air passage in the intake manifold is switched by the variable intake valve so that the passage length of the intake air passage in the intake manifold is reduced. In place of gas such as intake air or exhaust gas, liquid such as water, oil, or fuel may be used as fluid.

In the above embodiments, the valve driving device that drives and closes (or opens) the first to fourth intake air flow control valves 4 is constructed of the following: an electric actuator equipped with a power unit so constructed that it includes an electric motor and a power transmission mechanism (e.g. a mechanical reduction mechanism). Instead, the valve driving device that drives and opens or closes valves may be constructed of a negative pressure-operated actuator or an electromagnetic actuator equipped with an electromagnetic or electric negative pressure control valve. The valve biasing means, such as spring, for biasing valves in the valve opening direction or in the valve closing direction may be omitted. In the examples described above, butterfly valves that rotate on the rotation center axes of the first to fourth valve-side fitting portions 9 are used as the valves. Instead, any other valve, such as plate valve or rotary valve, may be used.

In the above embodiments, the invention is applied to an in-line four-cylinder engine in which cylinders are arranged in groups. Instead, the invention may be applied to an internal combustion engine having multiple banks in which cylinders are arranged in groups. Such internal combustion engines include multicylinder engines such as V-type engine, horizontal engine, and horizontal opposed engine. In the above embodiments, the outside shape (shaft shape) of the shaft outside diameter portion 29 of the valve shaft 5 is polygonal (e.g. octagonal). Instead, the shaft outside diameter portion may be formed in circular shape. In the above embodiments, the hole shape of each of the first to fourth shaft through-holes 10 in the first to fourth intake air flow control valves 4 is round. Instead, the first to fourth shaft through-holes may be formed in polygonal shape or in D shape.

While only the selected embodiments have been chosen to illustrate the present invention, it will be apparent to those skilled in the art that various changes and modifications can be made therein without departing from the scope of the disclosure as defined in the appended claims. Furthermore, the foregoing description of the embodiments herein is provided for illustration only, and not for the purpose of limiting the disclosure as defined by the appended claims and their equivalents.

What is claimed is:

1. A manufacturing method for a plural valve assembly comprising:
providing a plurality of housings that each define a channel, wherein each housing includes at least one valve anchoring portion;
providing a plurality valves;
providing a shaft;
coupling the plurality of valves to corresponding ones of the housings such that the valves can move relative to the housing between an open position and a closed position, wherein the valves abut against the respective at least one valve anchoring portion in the closed position;
coupling the shaft to the plurality of valves, wherein each of the plurality of valves abuts against the respective at least one valve anchoring portion as the shaft is coupled thereto.

2. The manufacturing method according to claim 1, wherein the coupling of the shaft to the plurality of valves comprises frictionally coupling the shaft to the plurality of valves.

3. The manufacturing method according to claim 1, wherein at least one of the housings, the valves, and the shaft is made out of resin.

4. The manufacturing method according to claim 1,
wherein the plurality of valves comprise a through-hole,
wherein the coupling of the plurality of valves to corresponding ones of the housings comprises coupling the valves such that the through-holes are substantially perpendicular to an axis of the respective channel, and
wherein the coupling of the shaft to the plurality of valves comprises inserting the shaft in the at least one through-hole.

5. The manufacturing method according to claim 4,
wherein the through-holes are aligned; and
wherein at least two of the through-holes have different diameters,
wherein the shaft has an outer diameter that varies along a length of the shaft such that an anterior end of the shaft is smaller than a posterior end of the shaft, and
wherein the coupling of the shaft to the valves comprises inserting the anterior end into the housings before the posterior end.

6. The manufacturing method according to claim 5, wherein the outer diameter of the shaft is tapered so as to increase in size from the anterior end to the posterior end.

7. The manufacturing method according to claim 5, wherein the outer diameter of the shaft is stepped, such that the outer diameter of the shaft increases in size in steps from the anterior end to the posterior end.

8. The manufacturing method according to claim 1, wherein the shaft is at least partially formed of metal.

9. The manufacturing method according to claim 1,
wherein the shaft has at least one knurled portion that frictionally fits to a corresponding one of the plurality of valves.

10. The manufacturing method according to claim 1, wherein coupling the shaft to the plurality of valves comprises welding the shaft to the plurality of valves.

11. The manufacturing method according to claim 10, wherein coupling the shaft to the plurality of valves comprises at least one of vibration welding and laser welding the shaft to the plurality of valves.
